(19) United States
(12) Patent Application Publication
(10) Pub. No.: US 2011/0107604 A1
(43) Pub. Date: May 12, 2011

(54) HAIR CLIPPER WITH CUTTING GUIDE

(75) Inventor: Pierre Julemont, Soumagne (BE)

(73) Assignee: Faco S.A., Wandre (BE)

(21) Appl. No.: 12/933,543

(22) PCT Filed: Mar. 13, 2009
(86) PCT No.: PCT/EP2009/052978

§ 371 Date: Dec. 15, 2010

(30) Foreign Application Priority Data
Apr. 8, 2008 (EP) 084447023.6

(51) Int. Cl. B26B 19/20

(52) U.S. Cl. 30/201

(57) ABSTRACT

This invention relates to a hair clipper with a cutting mechanism and a cutting guide, said cutting mechanism defining a cutting line and said cutting guide comprising a foot with an angled bearing surface, the distance between said cutting line and said angled bearing surface of the foot determining the length at which the hair is cut, which clipper has a control member which, when the cutting length is adapted, allows said cutting line and said angled bearing surface of the foot to move relative to each other along a curved path.

### FIELD OF THE INVENTION

The present invention relates to a hair clipper comprising a cutting guide which, when in use, allows to adjust the cutting length by varying the distance between the cutting mechanism and the cutting guide by means of a control element along a curved path.

### STATE OF THE ART

In order that a user, usually not a professional hairdresser, can ensure quality work by using a hair clipper fitted with a cutting guide, he must always follow an optimal working angle between this cutting guide and the curvature of the skull.

A cutting guide device is generally made up of a comb with a support surface and at least one holding arm which secures the cutting guide to the hair clipper. Some cutting guides also benefit from a nesting. For simplicity purposes, reference shall be made herein below to a pad and no longer to a comb, knowing that the pad embodies the support surface of the cutting guide.

In the state of the art, there are, on the one hand, telescopic cutting guides comprising a support surface that is approximately flat. Maintaining the cutting guide in a position that is perpendicular relative to the skull is difficult and requires permanent adjustment of the inclination of the hair clipper for every movement on the skull, and especially, each time the cutting length is adjusted (see FIGS. 1 and 2).

On the other hand, there are other non-telescopic cutting guides that have an elbowed support surface. They are nested on the hair clipper and the models to be nested are chosen depending on the desired cutting heights. These elbowed guides allow freedom of movement (tilting) by more or less 15 degrees relative to that of the skull's normal curvature, while ensuring a constant cutting length. This greatly increases the comfort of use. However, to change the cutting length, the height of the pad must be adjusted by switching with another part (see FIG. 3).

When the user wishes to adjust the cutting length by adjusting the distance between the cut line and the support surface of the cutting guide on the skull, he can presently choose between two options:
He uses a telescopic cutting guide with a support surface that is essentially flat, which of course allows to automatically adjust the cutting length by means of a control element, but which offers very little freedom of movement since it does not have any elbowed support surface. The difficulty of such an adjustment is outlined in FIGS. 1 and 2. These figures also show that a rectilinear translation with an elbowed pad (not shown) would be very problematic since the cutting length would no longer be defined in relation to a concentric circle about the cut line, in which the elbow would be inscribed. The advantage of the elbow and the freedom of movement that it provides would therefore be lost.
He uses a non-telescopic cutting guide with an elbowed support surface (pads of different heights as shown in FIG. 3) that is adjustable on the hair clipper and does not allow to automatically adjust the cutting length by means of a control element connected to the guide, but that offers some freedom of movement about a tilting line located on the elbow of the support surface (see FIG. 3).

Documents WO 2007/006106 A1, EP 150305 A, DE 10246519, US 2003/204956 A1, EP 0484795 A, U.S. Pat. No. 3,287,805 A and GB 04600 all disclose hair clippers belonging to one or the other of the above-described categories.

Document U.S. Pat. No. 2,593,168 discloses a hair clipper with a cutting guide comprising a pad that is substantially flat. The pad does not have a tilting line about which some freedom of movement could occur. The inclination of the guide can be changed by means of a fixing screw of the guide on the hair clipper, the guide comprising a slot that co-operates with a fixing screw for adjusting the position. This type of guide allows all types of adjustments both in terms of length and in terms of contact angle with the skull without however offering the possibility to automatically adjust the cutting length by means of a control element and without enjoying the advantages of an elbowed pad.

Document WO 98/25735 discloses a hair clipper where a control element placed on a curved slide allows to adjust the distance between the cut line and the pad surface according to a straight line by means of a connecting rod. Only the control element moves along a curve to follow the shape of the hair clipper shell. The relative movement of the cut line in relation to the pad does not therefore occur along a curved path.

### AIMS OF THE INVENTION

The present invention aims to provide a hair clipper without the drawbacks of the state of the art. In particular, it aims to provide a hair clipper allowing to vary the distance between the support surface of an elbowed pad and the cut line by a control element, while continuing to inscribe the curvature of the pad elbow in a concentric circle about the cut line.

The invention aims therefore to provide a hair clipper with a cutting guide having a pad with an elbowed support surface and thus giving some freedom of movement during the cutting of hair, whilst providing the possibility to automatically adjust the cutting length by means of a control element and greater accuracy of work.

### Characteristic Features of the Invention

The present invention discloses a hair clipper comprising a cutting mechanism and a cutting guide, said cutting mechanism defining a cut line and said cutting guide comprising a pad with an elbowed support surface, the distance between said cut line and said elbowed support surface of the pad determining the cutting length of hair, said hair clipper comprising a control element allowing said cut line and elbowed surface support of the pad to move relative to each other along a curved path, whilst the cutting length is being adjusted.

The particular embodiments of the invention comprise at least one, or any suitable combination of several of the following characteristics:
said curved path is a portion of a circle centred on an rotation axis (pivot axis);
said rotation axis is real or virtual;
said pad is connected by a connection means to said control element;
said connection means is connected to a curvilinear arm cooperating with a slide;
said cutting mechanism is connected by a connection means to said control element;
the radius of the elbow of said elbowed support surface of the pad is essentially inscribed in a concentric circle about the cut line of said hair clipper;
said control element is a wheel or a slide;
said pad is detachable from said hair clipper;
said pad comprises an indication for the adjustment of the cutting length;
the adjustment of the distance between said elbowed support surface of the pad and said cut line is powered;
the adjustment of the distance between said elbowed support surface of the pad and said cut line is powered and pre-programmed for some cutting lengths to be chosen by the user.

### SHORT DESCRIPTION OF THE DRAWINGS

FIGS. 1 and 2 show a side view of a telescopic cutting guide according to the state of the art with an essentially flat pad repositioning itself along a rectilinear path. Letters X and A as well as Y and B show the movement of the contact point of the cutting guide on the skull when the distance between the cut line and the support surface of the pad is increased in a rectilinear manner.

FIG. 3 shows a non-telescopic guide according to the state of the art fitted with pads comprising an elbowed support surface with interchangeable combs/pads. In this case, the cutting lengths cannot be adjusted by means of a control element located on the hair clipper, and a special pad is required for each cutting length.

FIG. 4 shows a schematic view of the first embodiment of the invention. In this embodiment, the cutting mechanism is fixed and the pad of the cutting guide is mobile. The figure shows the rotation axis 12 about which the repositioning of the cutting guide occurs. In this case, axis 12 is virtual. The repositioning occurs by means of a curvilinear arm 3 which slides into a slide. The pad is connected to the control element 17 by a control rod 13.

FIG. 5 shows a schematic view of a second embodiment of the invention. In this embodiment, the cutting mechanism is again fixed and the pad of the cutting guide is mobile. The figure shows the rotation axis 12 about which the repositioning of the cutting guide occurs. In this case, axis 12 is materialised through a hinge. The connection means is represented by a control rod 13 connected to a control element 17.

FIG. 6 shows a schematic view of a third embodiment of the invention which combines the first and second embodiments. In this embodiment, the cutting mechanism is again fixed and the pad of the cutting guide is mobile. The figure shows the rotation axis 12 about which the repositioning of the cutting guide occurs. In this case, axis 12 is again virtual. The connection means is represented by a control rod 13 connected to a control element 17, but the pad also comprises a curvilinear arm cooperating with a slide 4.

FIGS. 7 and 8 show a schematic view of a fourth embodiment of the invention wherein the cutting mechanism 8 moves relative to the cutting guide by means of a connection means 11 which connects this cutting mechanism to a control element 17. In this embodiment, the cutting guide remains fixed and only the cutting mechanism 8 moves. The rotation axis 12 about which the repositioning of the cutting mechanism occurs is shown. In this case, the axis is again virtual.

FIGS. 9 and 10 show a side view of the first embodiment of the hair clipper 1 according to the invention. The elbow of the pad is essentially inscribed in a circle about the cut line 6, which allows a freedom of movement of ±15 degrees relative to the normal to the skull. The 30-degree angle is shown in FIG. 10. The cutting guide is adjusted to a variable cutting length of 3 mm to 18 mm. In FIG. 9, the control element 17 is a wheel 5.

FIGS. 11 and 12 show the same embodiment as that shown in FIGS. 9 and 10, but with a cutting guide adjusted to a variable cutting length of 21 mm to 36 mm.

FIG. 13 shows a view with a pad 16 that is detachable from its guide according to a particular embodiment of the invention.

FIGS. 14 and 15 show general 3D views of the first embodiment of the invention.

### NUMERICAL REFERENCES OF THE DRAWINGS

1. Hair clipper with cutting guide
2. Cutting guide
3. Curvilinear holding arm of the cutting guide in the slide
4. Curvilinear slide
5. Wheel/slide for adjusting the cutting length (particular form of a control element)
6. Cut line
8. Cutting mechanism
9. Tangent to the surface of the skull
10. Surface of the skull
11. Connection means of the cutting mechanism 8 to the control element 17
12. Rotation axis or pivot axis of the elbowed pad of the cutting guide
13. Connection means between the pad 16 and the control element 17
14. Concentric circle about the cut line within which the elbowed support surface of the pad 16 is essentially inscribed
15. Movement according to a curve of the elbowed support surface of the pad about the axis 12 (virtual or real)
16. Pad and/or comb
17. Control element
18. Knife on the cutting mechanism 8

### DETAILED DESCRIPTION OF THE INVENTION

The present invention discloses a hair clipper 1 with a cutting guide 2 which combines the advantages of a cutting guide with an automatic adjustment of the cutting length by a control mechanism with those of a cutting guide comprising a pad or a comb with an elbowed support surface allowing greater freedom of movement about a tilting line.

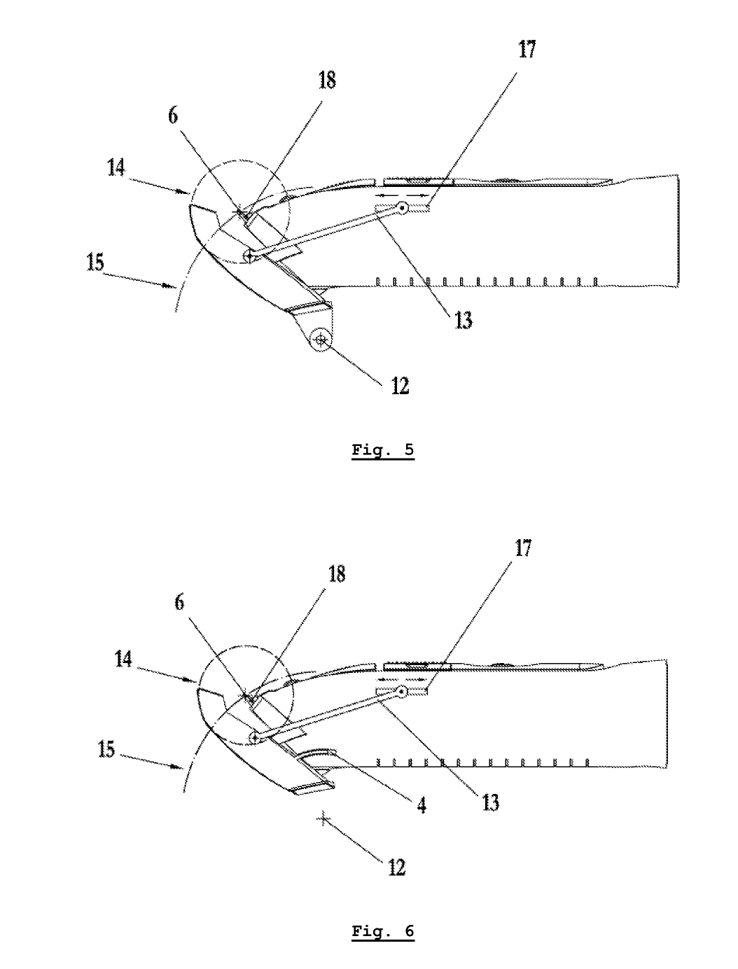

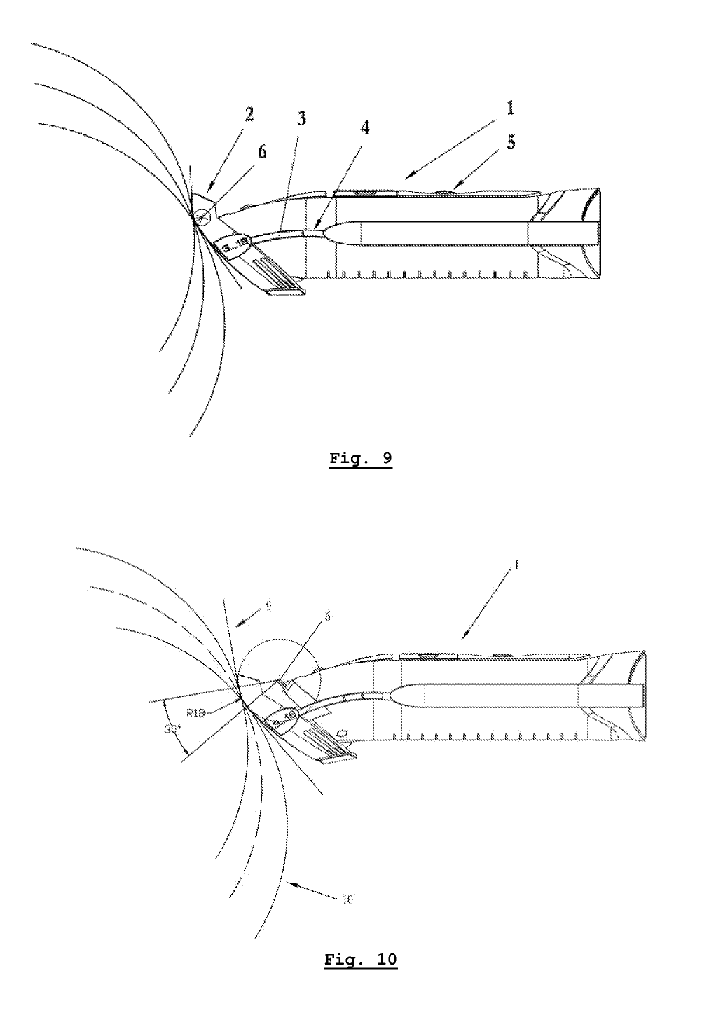

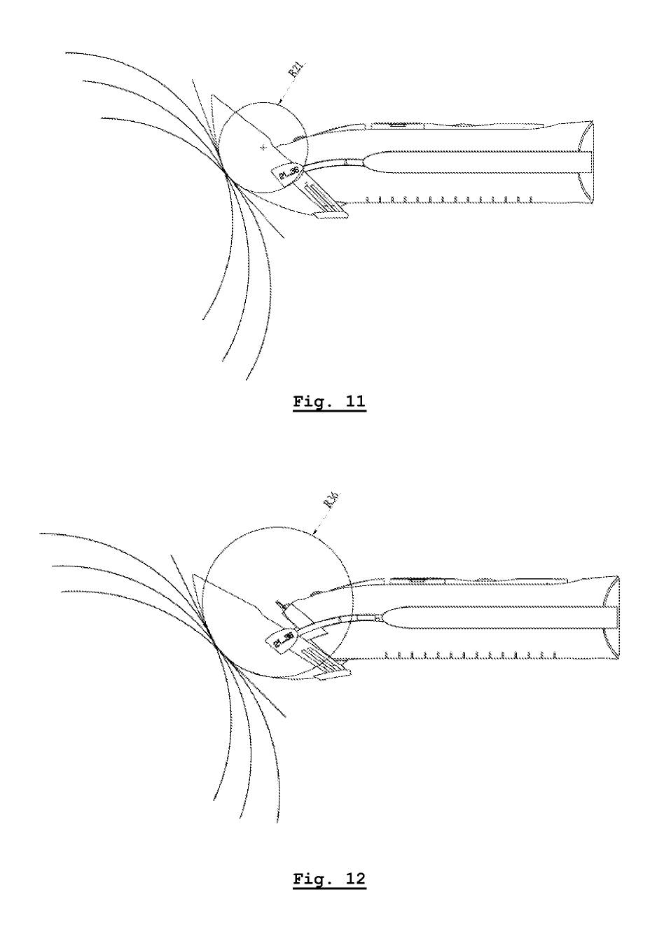

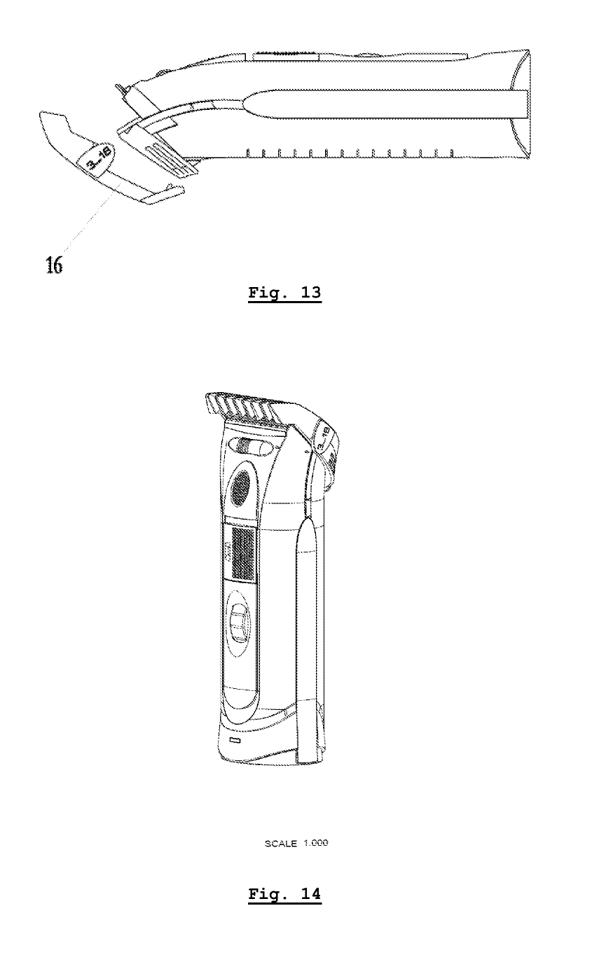

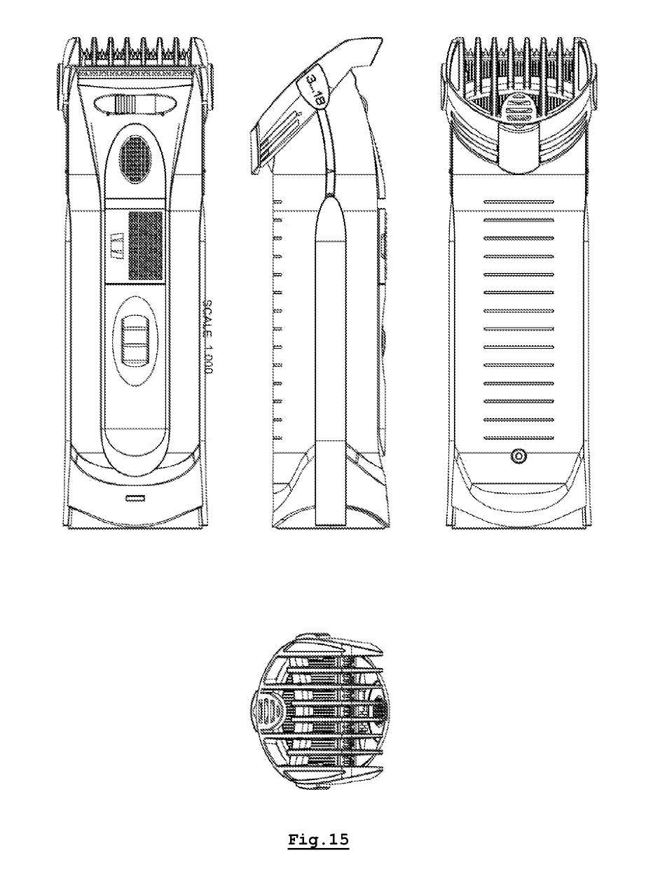

To make a cutting guide comprising a single elbowed pad operational on several cutting lengths, it was not enough to adapt a simple telescopic mechanism with rectilinear movement on this pad. A simple rectilinear movement of the elbowed pad 16 would have brought the radius of the elbow of the pad out of the concentric circle 14, which ensures equidistance relative to the cut line 6. Now, to continue enjoying the advantages of an elbowed pad which allows movement about a tilting line, it is important that the radius of the elbow of the pad continues to be essentially inscribed in a concentric circle 14 about the cut line 6 (see in particular FIGS. 4, 5, 6 and 9, 10, 11 and 12).

The purpose of combining the two known advantages of the state of the art (flat telescopic pad with switchable elbowed pad) could therefore only be achieved by inventing a hair clipper on which it was possible to vary the distance between the cut line 6 and the support surface of the elbowed pad 16 according to a curved path, and preferably according to a rotation movement about an axis 12. This rotation axis may be virtual, i.e. located outside the hair clipper, or be materialised by a hinge on the hair clipper.

To achieve this purpose, there are three possibilities. Either the position of the pad relative to the cut line is adjusted, or the position of the cutting mechanism relative to the support surface of the pad is adjusted. These two possibilities are shown in the drawings. A third possibility is to vary both the position of the pad 16 and that of the cutting mechanism 8. This possibility is not represented here but is an integral part of the invention.

Maintaining a certain freedom of movement about the tilting line has really been achieved only by inscribing the elbow of the elbowed support surface of the pad or comb 16 within a concentric circle 14 about the cut line 6 as mentioned above.

The expression “essentially inscribed within the concentric circle” means inscribed with a certain tolerance in this concentric circle and within the limits of the practical feasibilities. It is evident that for a variable cutting length of 3 to 18 mm, a mean curvature inscribed at best in this concentric circle should be chosen, knowing that for a very short cutting length, only a small proportion of the elbow is involved, while for a longer cutting length, a larger support surface of the elbowed pad will be inscribed in this circle.

As mentioned above, only a curved movement, preferably about a virtual or real axis 12, could provide the correct repositioning of the elbowed pad relative to the cutting mechanism 8 without losing the advantage of a freedom of movement for which this type of elbow was created.

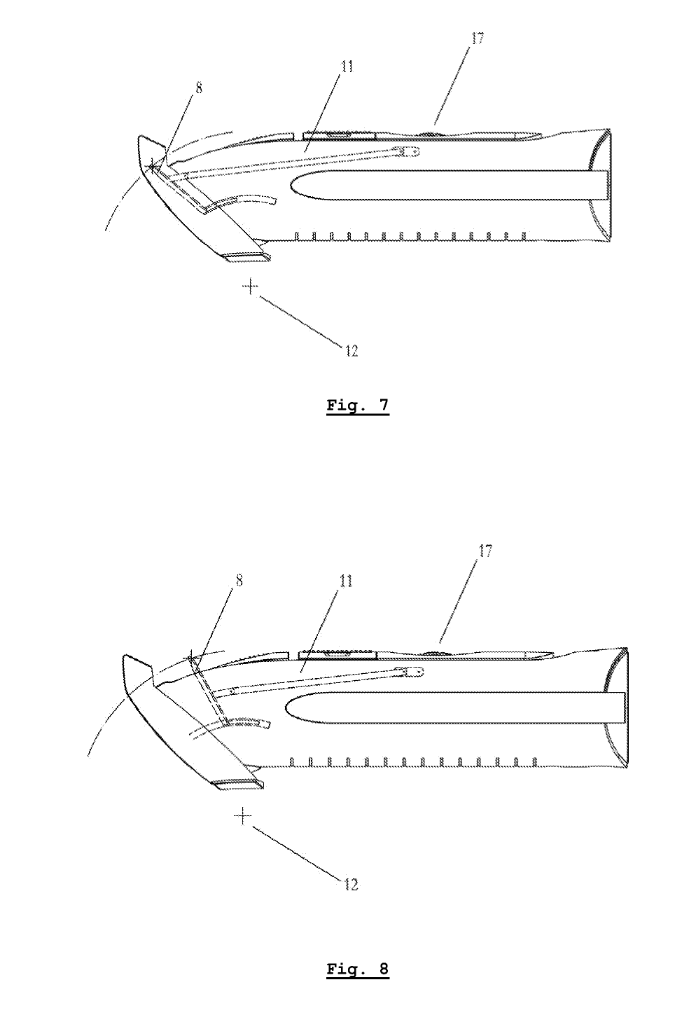

To ensure movement about this axis, it was necessary to connect the pad 16, the cutting mechanism 8 or both to a control element 17. The nature of this connection is none too important, and any means adapted for this function may be convenient. In FIGS. 4, 5, 6, 7 and 8, various means are schematically shown, but of course, they are not exhaustive.

A preferred embodiment of this patent is amply shown in the last drawings, where the movement about the axis 12 is ensured by an arm 3 which evolves in a slide 4 and which is controlled by a wheel 5. This operation may of course be powered and even pre-programmed for some specific cutting lengths.

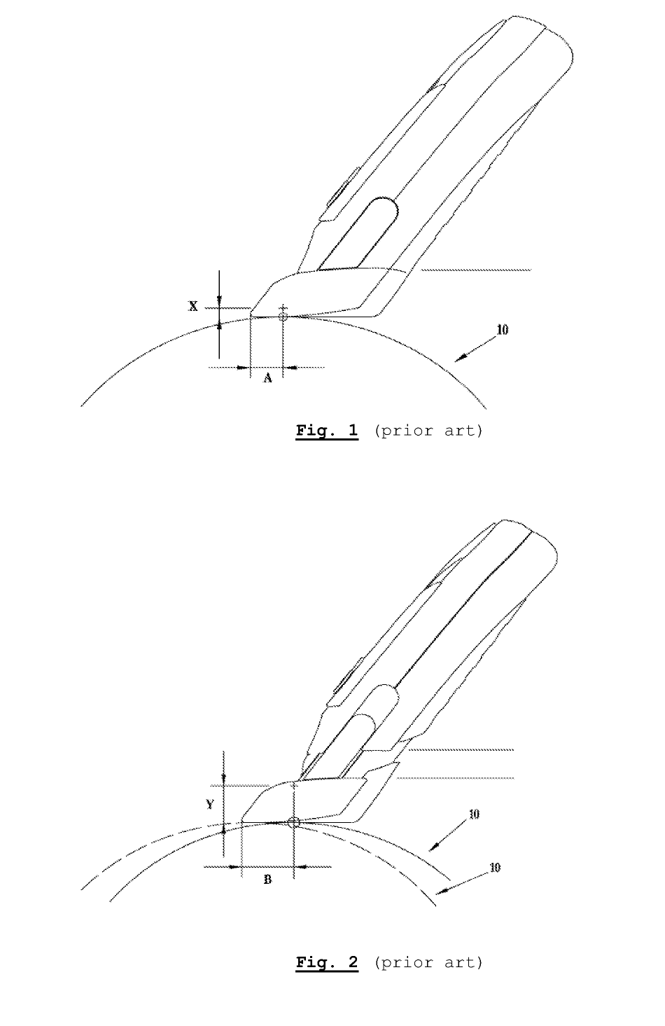

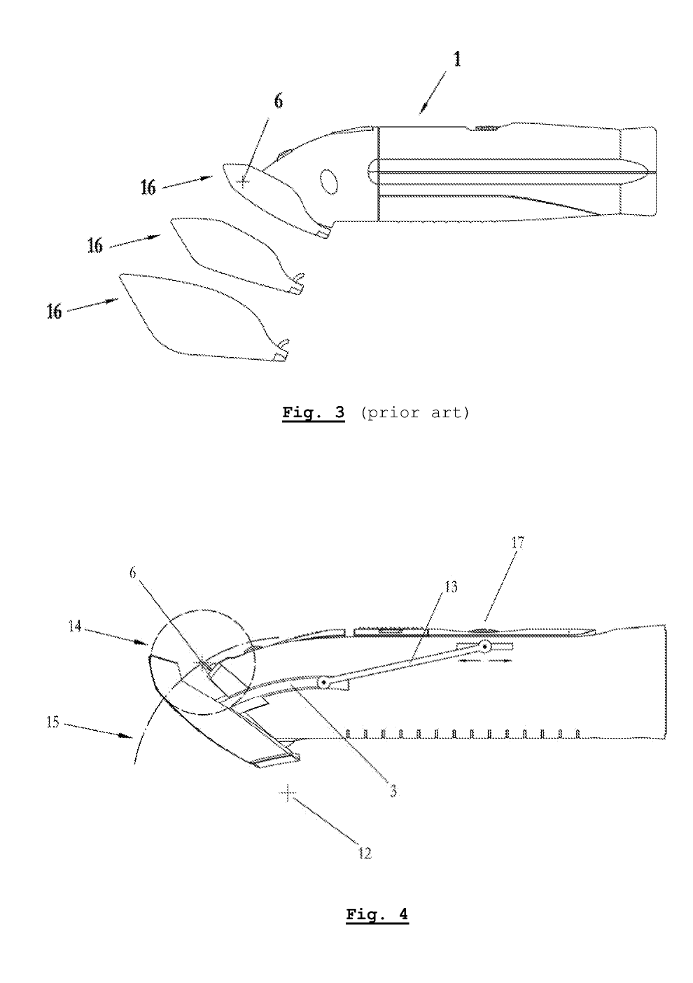

The hair clipper according to the invention may also comprise a marking on the pad allowing to adjust the desired cutting length. These markings appear in FIGS. 1 to 4 and range from 3 to 18 mm and from 21 to 36 mm.

Pad 16 located on its guiding device can also be provided to be detached so as to be replaced by a pad with a different range of cutting lengths (see FIG. 13).

1. Hair clipper (1) comprising a cutting mechanism (8) and a cutting guide (2), said cutting mechanism (8) defining a cut line (6) and said cutting guide (2) comprising a pad (16) with an elbowed support surface, the distance between said cut line (6) and the elbowed support surface of the pad (16) determining the cutting length of hair, said hair clipper (1) comprising a control element (17) allowing said cut line (2) and elbowed support surface of the pad (16) to move relative to each other along a curved path, when the cutting length is adjusted.

2. Hair clipper (1) as in claim 1, wherein said curved path is a portion of a circle centred on the rotation axis (12).

3. Hair clipper (1) according to claim 2, wherein said rotation axis (12) is real or virtual.

4. Hair clipper (1) as in any of the preceding claims, wherein said pad (16) is connected by a connection means (13) to said control element (17).

5. Hair clipper (1) as in claim 4, wherein said connection means (13) is connected to a curvilinear arm (3) cooperating with a slide (4).

6. Hair clipper (1) as in any of the preceding claims, wherein said cutting mechanism (8) is connected by a connection means (11) to said control element (17).

7. Hair clipper (1) as in any of the preceding claims, wherein the radius of the elbow of said elbowed support surface of the pad (16) is essentially inscribed in a concentric circle (14) about the cut line (6) of said hair clipper (1).

8. Hair clipper (1) as in any of the preceding claims, wherein said control element (17) is a wheel (5) or a slide.

9. Hair clipper (1) as in any of the preceding claims, wherein said pad (16) is detachable from said hair clipper (1).

10. Hair clipper (1) as in any of the preceding claims, wherein said pad (16) comprises an indication for the adjustment of the cutting length.

11. Hair clipper (1) as in any of the preceding claims, wherein the adjustment of the distance between said elbowed support surface of the pad (16) and said cutting line (2) is powered.

12. Hair clipper (1) as in any of the preceding claims, wherein the adjustment of the distance between said elbowed support surface of the pad (16) and said cut line (2) is powered and pre-programmed for certain cutting lengths to be chosen by the user.
